(19) United States
(12) Patent Application Publication
(10) Pub. No.: US 2003/0222252 A1
(43) Pub. Date: Dec. 4, 2003

(54) Reversible motorcycle support

(76) Inventor: Charles Nicholas VanValkenburgh, Huntsville, AL (US)

Correspondence Address: Charles Nicholas VanValkenburgh, 620 Pearl Avenue, Huntsville, AL, 35801, US

(21) Appl. No.: 10/447,342

(22) Filed: May 29, 2003

Related U.S. Application Data
(60) Provisional application No. 60/383,940, filed on May 30, 2002.

(51) Int. Cl. B66F 3/00

(52) U.S. Cl. 254/131

(57) ABSTRACT

A device for use in conjunction with a standard swingarm stand for a motorcycle consisting of a reversible bracket that will engage traditional swingarms or swingarms equipped with spools. The reversible bracket mounts to the stand at the point of engagement with the swingarm and can be adjusted for different width swingarms.

### CROSS REFERENCE TO RELATED APPLICATIONS

This application claims the benefit of the filing date of provisional application No. 60/383,940 entitled “Reversible Motorcycle Support” filed May 30, 2002.

### BACKGROUND OF THE INVENTION

The present invention relates to motorcycle stands, and more particularly, to stands designed to support the underside of the rear swingarm of a motorcycle.

Motorcycle swingarm stands are a common tool used to support a motorcycle to allow for maintenance such as chain maintenance, changing of tires or cleaning. Unlike a side stand and a center stand which are permanently connected to the motorcycle, a typical swingarm stand is a separate device that engages the lower face of the rearward portion of each side of a motorcycle swingarm and is designed such that a simple downward rotation lifts the rear wheel off the ground and securely holds the motorcycle in that position. Some motorcycle swingarms are equipped with small horizontal projections called “spools” for secure engagement with mating brackets on the swingarm stand. Spools simplify the engagement process and improve stability and are typically found on road racing motorcycles that are not equipped with a side stand or a center stand. The structure of swingarm stands vary, but whatever the configuration, a stand will be either equipped to support standard or spooled swingarms but not both. This means that two different stands were necessary in order to support motorcycles with spools and standard swingarm motorcycles. This invention is directed to making a rear stand universal for both types of swingarm, thus eliminating the need for duplication of otherwise similar stands.

### BRIEF SUMMARY OF THE INVENTION

The present invention is an improvement to a motorcycle swingarm stand that will enable a single stand to provide support for motorcycles with either a standard swingarm or a spool-equipped swingarm. A typical motorcycle rear stand is modified to incorporate a bracket that can be easily switched to engage either the standard or the spooled swingarm. The bracket is also width adjustable to conveniently fit different motorcycle swingarms.

A typical swingarm stand consists of a support structure made from round or square tubing designed to be operated by hand and lift the rear wheel of a motorcycle off the ground. A pair of vertically disposed arms are equipped with a bracket at the upward end that engages the bottom face of the swingarm or engages spools affixed to the swingarm. The improved bracket is configured so that it may be reversed to engage both types of swingarms as necessary.

Other objects and advantages of the present invention will be apparent from the following description, the accompanying drawings and the appended claims.

### BRIEF DESCRIPTION OF THE DRAWINGS

FIG. 1 is a perspective view of the improved stand

FIG. 2 is a perspective view of the improved bracket in detail

FIG. 3 is a perspective view of a motorcycle swingarm equipped with spools with a rear stand in the ready position.

FIG. 4 is an elevation view of a swingarm stand in operation.

FIG. 5 is a perspective view of an alternative embodiment of the reversible bracket.

FIG. 6 is a perspective view of an alternative embodiment of the reversible bracket.

### DESCRIPTION OF THE PREFERRED EMBODIMENT

As shown in FIG. 1, the swingarm stand of the present invention is designated generally at 10. The stand has a support frame 12 with two parallel generally vertical but slightly rearwardly disposed tubes 14,15 at the lower portion of which are connected two rearwardly disposed horizontal tubes 16,17. The rearward ends of horizontal tubes 16,17 are connected by a horizontal transverse member 18. The transverse member 18 also serves as handle for holding the stand during operation. Attached at the base of vertical members 14,15 a pair of forward and longitudinally disposed wheels 19 are affixed by brackets 20. The stand structure disclosed above is for the purpose of describing the function of a swingarm stand generally and any structural configuration that accomplishes the same end is contemplated.

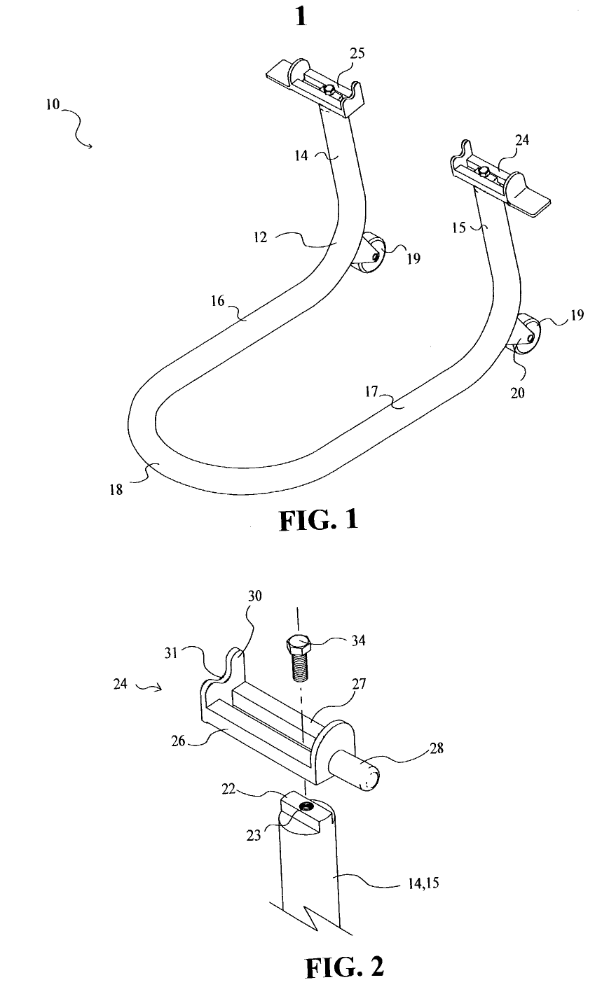

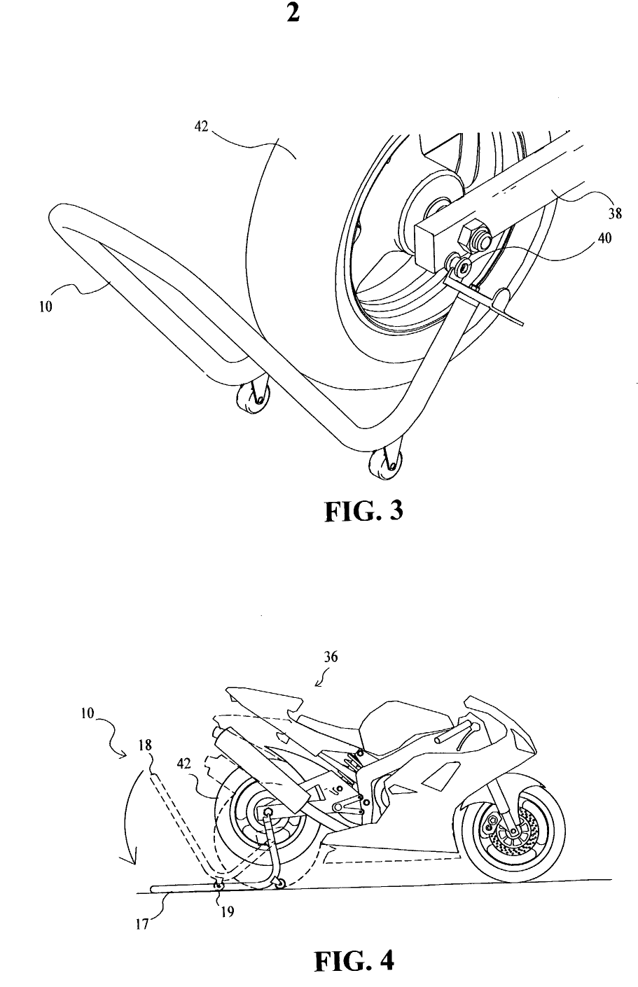

FIG. 2 shows a detail of the preferred embodiment of the present invention. The top of vertical tubes 14,15 are configured with a transversely disposed guide 22. A vertically disposed threaded hole 23 is provided in the top of guide 22 for attaching the reversible bracket shown generally at 24. Reversible bracket 24 is configured with a pair of transverse members 26,27 spaced such that they will fit slidably over the guide 22 but prevent rotation of bracket 24. Nothing in this disclosure is meant to limit transverse members 26,27 and guide 22 to the square profile shown in FIG. 2, but may be round or of some other design that provides the same orienting function of said members. Bracket 24 is provided with a standard swingarm engaging member 28 attached to one end of transverse members 26,27. Standard engaging member 28 functions to contact the lower face of a swingarm and may be a horizontally disposed cylindrical member as shown in FIG. 2, or may have a flat surface of some other design that provides adequate support for the motorcycle. A spool engaging member 30 is affixed to transverse members 26,27 at the opposite end from standard engaging member 28. Spool engaging member 30 has a vertically disposed, generally flat configuration that has a v-shaped or semi-circular profile 31 on its upper edge to fit securely around the spool 40 (see FIG. 3).

Bracket 24 is attached to guide 22 by means of a bolt 34. The bolt 34 can be loosened and bracket 24 can be lifted vertically so the transverse members 26,27 clear guide 22 and the bracket then spun 180 degrees so the opposite end of bracket 24 is now in the functioning position. With bolt 34 still loose, brackets 24 and 25 can be adjusted in the transverse direction to whatever width necessary, then bolt 34 tightened.

Operation of the stand 10 is shown generally in FIGS. 3 and 4. The brackets 24 are first properly set up to fit the desired swingarm style and width. FIG. 3 shows a swingarm 38 equipped with spools 40. The stand 10 is place so the spool engaging member 30 of bracket 24 contact the spools 40. FIG. 4 shows the operation of the stand 10. A downward force is applied to cross member 18 which causes the stand wheels 19 to roll along the floor and lift the swingarm 38 until horizontal members 17 contact the floor, simultaneously raising the wheel 42 from floor and stabilizing the motorcycle 36. Raising the cross member 18 reverses the process and lowers the motorcycle wheel 42 until it makes contact with the floor.

FIG. 5 shows an alternative embodiment of the present invention. A rotatable bracket 50 is attached to the top of the vertical tubes 14,15 by means of a removable pin 52 inserted through holes 54 in the bracket and in the vertical tubes 14,15. Removal of the pin 52 allows the bracket 50 to be rotated 180 degrees in a plane perpendicular to the vertical tube 14,15. Bracket 50 is provided with standard swingarm engaging means 56 and spool engaging means 58. Means may be provided for adjusting the width similar to the previous disclosure.

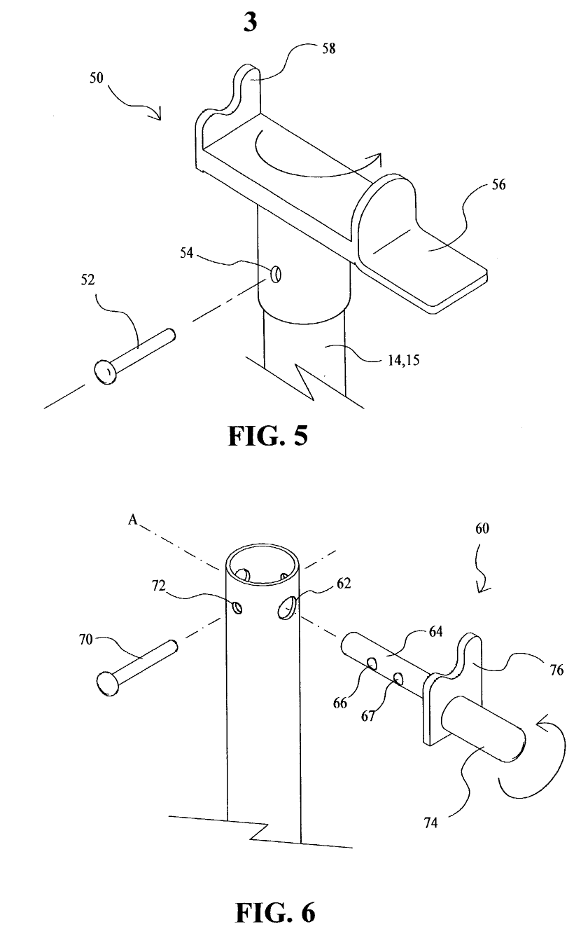

Another embodiment is shown in FIG. 6. A bracket 60 is contemplated that is rotatable about an axis “A” perpendicular to vertical tubes 14,15. The bracket 60 is equipped with a horizontally disposed main support shaft 62 that is inserted through a hole 64 in the top of vertical tubes 14,15. Adjustment holes 66,67 are provided in the shaft 64 to secure the bracket and provide for width adjustments. The shaft 62 is secured by means of a pin 70 that is inserted through a hole 72 in vertical tubes 14,15. Bracket 60 is provided with means 74 for engaging a standard swingarm and spool engaging means 76 located 180 degrees from standard means 74. Adjustment is accomplished by removing pin 70 and rotating bracket 60 about axis A and reinserting pin 70 through hole 64 and appropriate hole 66 or 67.

What I claim is:

1. a swingarm stand with a supporting end and a leverage end for supporting the rear end of a motorcycle by engagement with the swingarm of said motorcycle or spools affixed to said swingarm of said motorcycle, wherein the improvement comprises;
a. a pair of reversible, transversely adjustable brackets attached to the supporting end of said swingarm stand, each of said brackets having a spool engagement end and a swingarm engagement end;
b. means for locking said brackets releasably to said supporting end of said swingarm stand.

2. the stand as claimed in claim 1 wherein said transversely adjustable brackets further comprise a rotatable coupling engagement with said supporting end of said swingarm stand,
means for locking said rotatable coupling to said supporting end of said swingarm stand;

3. a swingarm stand for supporting the rear end of a motorcycle by engagement with the swingarm of said motorcycle; said swingarm stand consisting of a support frame with parallel rearwardly disposed horizontal members with a forward end and a rearward end, said horizontal members are connected at the rearward ends by a transverse member that also serves as a leverage handle; a pair of slightly rearwardly disposed vertical members each with an upper end and a lower end, each of said vertical members is connected to the forward end of said horizontal members; a wheel is connected at the lower forward end of said vertical members to facilitate lifting of said motorcycle; the primary improvement comprising;
a. a pair of aligned transversely disposed guides at the top of said vertical members;
b. a pair of reversible, transversely adjustable brackets, said brackets having a swingarm engagement end and a spool engagement end;
c. means for releasably and adjustably affixing said brackets to said upper end of said vertical members; said brackets engaging said transversely disposed guides to prevent rotation of said brackets.
